(19) United States
(12) Patent Application Publication
(10) Pub. No.: US 2021/0207579 A1
(43) Pub. Date: Jul. 8, 2021

(54) VERTICALLY-ORIENTED WIND TURBINE AND IMPROVED WIND SHIELD

(71) Applicant: Gary Barben, Annabella, UT (US)

(72) Inventor: Gary Barben, Annabella, UT (US)

(21) Appl. No.: 17/141,980

(22) Filed: Jan. 5, 2021

Related U.S. Application Data
(60) Provisional application No. 62/957,269, filed on Jan. 5, 2020.

(51) Int. Cl. F03D 3/04; F03D 3/00

(52) U.S. Cl. CPC F03D 3/0418; F03D 3/005; F05B 2250/711; F05B 2240/211; F05B 2240/60; F05B 2240/12

(57) ABSTRACT

A vertical-axis wind turbine (VAWT) comprising a plurality of convex blades axially-rotating about a vertical axis. A wind shield rotating axially around the blades shields the blades facing convexly into the wind on the windward side of the turbine, the shield adapted to redirect wind moving against the shield to a high pressure zone on the concave side of the turbine blades. The radial distance between blades may vary along the chord length of the shield.

### FIELD OF THE INVENTION

This invention relates to vertical-axis wind turbines and more particularly related to a vertical-axis wind turbine with a jetted shield.

### BACKGROUND

### Description of the Related Art

Wind turbines for power generation are well-known in the art, having passed through several generations of technology, each improving upon previous technologies. The latest generation of wind turbines include vertical-axis wind turbines (VAWT) which comprise axially-rotating blades disposed around a vertically-oriented shaft.

Efforts to reduce dependence upon fossil fuels has led to increasing demand for efficient and relatively rugged wind turbines which provide substantial electric power in areas where the prevailing winds are sufficient to effect operation of the windmills/turbines over substantial periods of time.

The prior art teaches wind turbines and VAWT fabricated with a plurality of rotors which rotate axially about a vertical axis (or horizontal in the case of traditional wind turbines), converting the mechanical rotation of the rotors or blades to electrical energy for use in an external circuit using an induction motory and which often are used to distribute power over a distributed power grid or system. Slow and fast shafts moving are known in the art, with some wind turbines making use of gearboxes to increase the rotations per minute of a secondary shaft driving an induction generator. A major advantage of VAWT designs is that they do not require repositioning around a vertical axis when the wind changes directions.

Horizontally-rotating wind turbines (HAWTs) suffer from a general inefficiency as they do not output stored electricity when the ambient air is still. Only when wind speeds increase to a sufficient speed to overcome the force of friction between the rotors and the drive shaft do the rotors begin spinning and generating electricity. Sometimes a wind vane is used for determining whether a wind velocity has exceeded a threshold sufficient to spin the rotators, but energy is required to reposition HAWTs. VAWTs, on the other hand, may comprise wind vanes which automatically orient the VAWT into the wind and provide output in lower wind conditions.

Existing VAWT designs may include a fixed or moving blade-adjustment structure, such as a wind shield which blocks the wind but does not redirect it. In conventional VAWT designs, there are various angular positions for each blade wherein each blade has several angular positions at which they generate little or no torque at all as well as several positions in which, if exposed the wind, the blades would move backward counteracting the turbine.

It is desirable, and an object of the present invention, to provide an apparatus, system and method of generating electricity using a VAWT wind turbine which redirects wind striking the windward side of traditional wind shields to further power the turbine.

### SUMMARY

From the foregoing discussion, it should be apparent that a need exists for a vertical-axis wind turbine with improved wind shield. Beneficially, such a device would overcome inefficiencies with the prior art by providing an inexpensive, efficient means of redirecting air striking the windward surface of the wind shield.

The present invention has been developed in response to the present state of the art, and in particular, in response to the problems and needs in the art that have not yet been fully solved by currently available apparti. Accordingly, the present invention has been developed to provide a vertical-axis wind turbine comprising: a plurality of blades rotating axially about a substantially vertical shaft; an arcuate wind shield adapted to shield convexly-facing blades on a windward surface of the turbine against contact with oncoming airflow, the wind shield comprising: an arcuate inner surface spaced away from the blades; an arcuate scoop arching outwardly from the arcuate inner surface, the arcuate scoop angling forward of a forward edge of the arcuate inner surface, the arcuate inner surface and the arcuate scoop forming a wind channel terminating at one or more ejection ports positioned behind a concave face of the blades, the ejection ports adapted to redirect airflow forced into the open scoop to the concave face of the blades; wherein the wind shield affixes to the vertical shaft such that the wind shield may rotate axially about the shaft only in one of a clockwise or counterclockwise direction about the vertical shaft.

The wind turbine may further comprise an arcuate redirection shield positioned laterally to the blades, the redirection shield adapted to redirect airflow around the blades. The redirection shield may be affixed to the shield using one or more arcuate beams.

The redirection shield may be hingedly affixed to the shaft using one or more beams. In various embodiments, the redirection shield is hingedly affixed to the shaft using one or more beams.

One or more of the redirection shield and the shield may define a plurality of apertures spaced across an outer surface. The wind turbine may further comprise a wind vane affixed to the shaft and the shield such that the wind vane rotates axially about the shaft.

In some embodiments, a vertical height of the scoop exceeds a vertical height of the blades.

A second vertical-axis wind turbine is provided comprising: a plurality of blades rotating axially about a substantially vertical shaft; an arcuate wind shield adapted to shield convexly-facing blades on a windward surface of the turbine against contact with oncoming airflow, the wind shield comprising an arcuate inner surface spaced away from the blades; an arcuate scoop arching outwardly laterally from the arcuate inner surface, the arcuate scoop and arcuate inner surface forming a wind channel terminating at an opening positioned behind a concave face of a blade, the scoop adapted to redirect airflow forced into the scoop to a concave face of a blade; wherein the arcuate scoop and the inner surface are taller than the blades.

One or more of the inner surface and arcuate scoop may be fabricated from sheet metal.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1A is an upper, forward perspective view of a vertical axis wind turbine (VAWT) with an improved wind shield in accordance with the present invention;

FIG. 1B is an upper, forward perspective view of a VAWT with an improved wind shield in accordance with the present invention;

FIG. 2 is an upper, forward perspective view of a VAWT with an improved wind shield and weathervane in accordance with the present invention;

FIG. 3 is an upper, forward perspective view of a VAWT with an improved wind shield in accordance with the present invention;

FIG. 4 is an upper, forward perspective view of a VAWT in accordance with the present invention;

FIG. 5 is a top perspective view of a VAWT in accordance with the present invention;

FIG. 6 is a top perspective view of a VAWT in accordance with the present invention;

FIG. 7 is an upper, forward perspective view of a VAWT in accordance with the present invention;

FIG. 8 is a top perspective view of a VAWT in accordance with the present invention;

FIG. 9 is a top perspective view of a VAWT in accordance with the present invention;

FIG. 10 is an upper, forward perspective view of a VAWT assembly in accordance with the present invention;

FIG. 11 is a top perspective view of a VAWT assembly in accordance with the present invention; and

FIG. 12 is a top perspective view of a VAWT assembly in accordance with the present invention.

### DETAILED DESCRIPTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

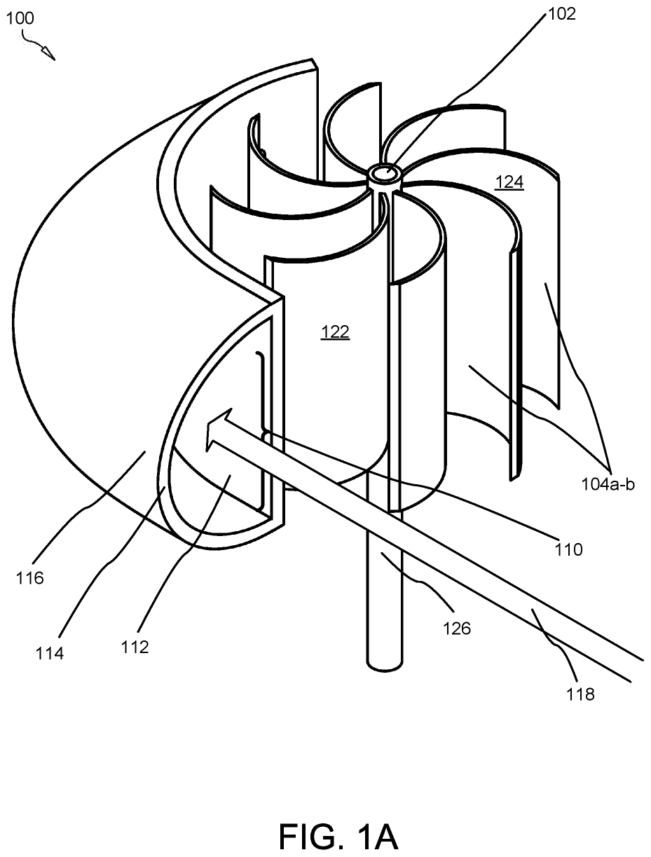

FIG. 1A is an upper, forward perspective view of a vertical axis wind turbine (VAWT) with an improved wind shield 100 in accordance with the present invention. The VAWT 100 comprises a shield 112 which positions laterally around the blades 104 of a the vertical axis wind turbine (VAWT) 100 such that wind or air flow which would push against an obverse side 122 of the blades 104 is instead directed partially around the blades 104. Airflow which would otherwise push against an obverse side 122 of the blades 104 is redirected to create a high pressure zone behind a reverse side 124 of the blades 104.

The blades 104 spin about an axle 126. An axis 102 traverses the longitudinal axis of the axle 126.

In various embodiments, a scoop 114 positions laterally of the shield 112. The scoop 114 may define a recess 110 for capturing airflow 118 crossing the shield 112 and redirecting said airflow 118 through a channel 116 to the back of the blades 104, further improving air pressure on the reverse side of the blades 104.

In some embodiments, the scoop 114 is taller in height than the blades 104.

FIG. 1B is an upper, forward perspective view of a VAWT with an improved wind shield 150 in accordance with the present invention.

The scoop 114, in some embodiments, angles forward of the forward edge of the shield 112. With this forward-angling leading edge, the scoop 114 better captures airflow 118. The forward edge of the shield 114 is shown to form a plane 154 in FIG. 1B.

The tunnel 116 (or channel) redirects airflow 118 around the obverse 122 sides of the blades 104 to an exit 152 in the shield 114. This exit 152 dispenses the airflow behind the blades 104 as they are angled into the direction of the wind.

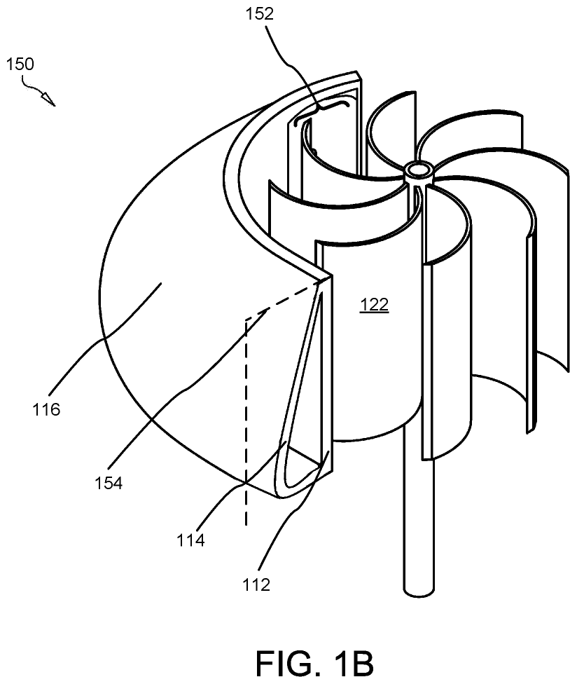

FIG. 2 is an upper, forward perspective view of a VAWT with an improved wind shield and weathervane 200 in accordance with the present invention.

In some embodiments of the present invention, a wind vane 202 positions superiorly or inferiorly to the blades 104 upon the axle 126. This wind vane 202 may be affixed to the shield 112 such that the shield 112 is positioned by the wind vane 202 into the oncoming wind 118 (or airflow 118). The wind vane 202 (i.e., wheather vane 202) thus is adapted to put the shield 112 and the scoop 114 into an optimal position against the oncoming wind 118, protecting the obverse sides 122 of the blades 114 from counteraxial pressure which would otherwise be applied to the obverse sides 122 of the rotating blades 104 by the airflow 118.

In various embodiments, the shield 112 rotates only clockwise or counterclockwise about the axis 102 from a top perspective, using means known to those of skill in the art to prevent counteraxial rotation (i.e., rotation against the direction intended of the shield 112 to prevent airflow 118 from counterrotating the shield). In this manner, the shield 112 is brought by the wind vane 202 into position against the airflow 118 and prevented from then rotating counteraxially back out of position from the counteraxial force of the airflow 118 as it travels through the tunnel 116.

The wind vane may comprise a trailing wind obstruction, adapted to ensure the wind vane positions with the obstruction trailing a trailing edge of the wind vane in the wind.

The scoop 114 may be shaped to protrude laterally more on a lower half of the shield than an upper half to catch airflow 118 being deflecting off an underlying structure upon which the apparatus 150 is mounted, such as a roof of a home.

The wind vane 202 is connected without intervening components to the shield 116 in the shown embodiment.

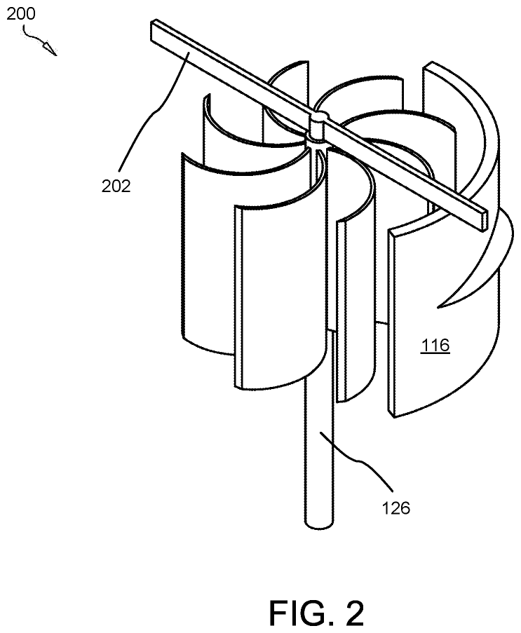

FIG. 3 is an upper, forward perspective view of a VAWT with an improved wind shield 300 in accordance with the present invention.

The assembly 302 comprises the shield 112, the scoop 114, and the tunnel 116 rotates axially about the axis 102 and is affixed to the shaft 102, such that the assembly 302 rotates independently of the blades 104 about the shaft 126 and axis 102.

A redirection shield 304 positions laterally of the reverse side 124 of the blades 104 as they are directed into the oncoming wind 118. The redirection shield 304 is arcuate on its inner surface such that oncoming airflow 118 striking the redirection shield 304 is redirected around the reverse side 124 of the blades 104.

The redirection shield 304 may be affixed to the shield 112 (or to the assembly 302) using one or more beams 306. These beams 306 may also be arcuate is shape, and may comprise tubular components or rigid shafts.

The redirection shield 304, like the shield 112 and tunnel 116, may be fabricated of metal alloy components or rigid polymeric materials.

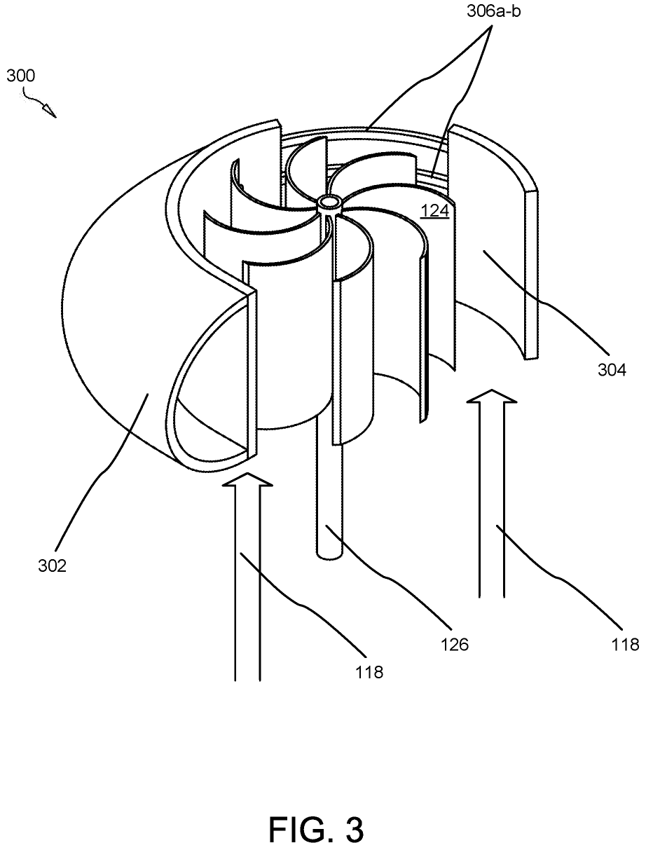

FIG. 4 is an upper, forward perspective view of a vertical axis wind turbine VAWT 400 in accordance with the present invention.

In some embodiments, the tunnel 116 comprises only a concave recess in the shield 112 which partially circumscribes the shield 112 axially.

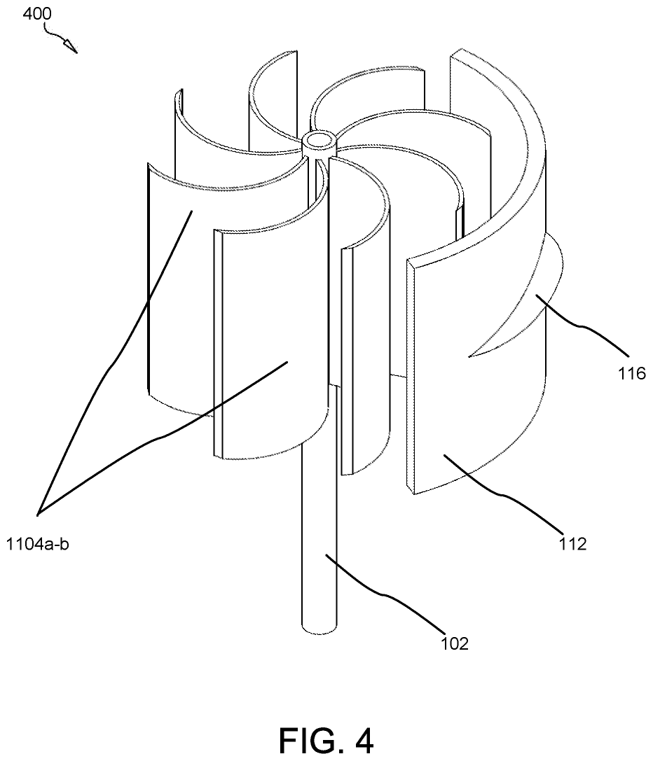

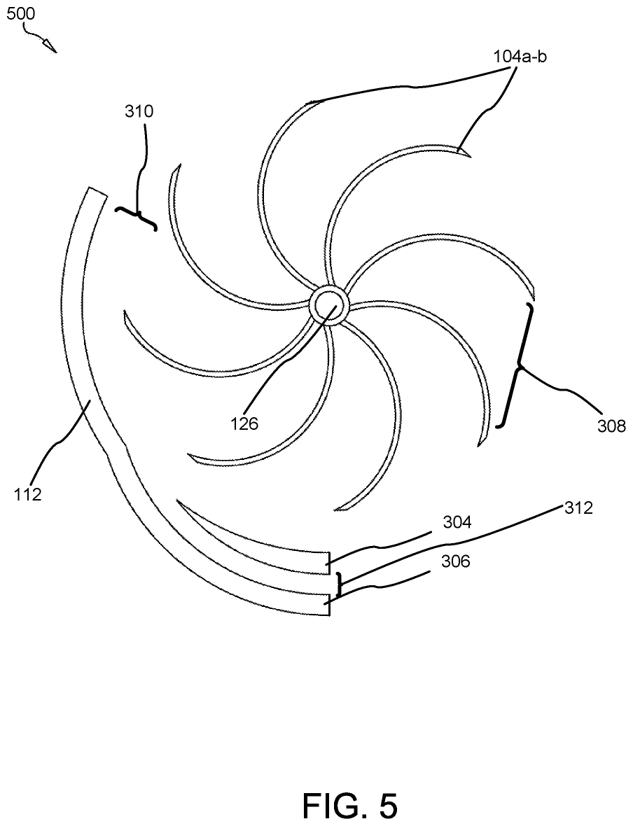

FIGS. 5-6 illustrate a top perspective view of a VAWT 500, 600 in accordance with the present invention;

In some embodiments, two shields 304, 306 partially circumscribe the blades 104 as shown which may be independently positioned around the blade 104 to improve air flow across the blades 104. These shields include an outer shield 306 and inner shield 304. A recess 312 may form between the shields 304, 306 to allow air to pass between said shields and be redirected to the blades, creating a high pressure region behind the reverse side 124 of the blades 104, which blades 104 may be concave or convex as shown (or arcuate).

The recess 312, in some embodiments, is preset to be between 90% and 190% of the width of the blades 104 from their outer edge to the axis 102.

A second recess 310 forms between the outer shield 306 and the outer edge of the blades 104 which is the distance from the inner edge of the outer shield 306 to the blades 104. This recess may be between 90% and 210% of the width of the blades 104 from their outer edge to the axis 102.

In some embodiments, the inner shield 304 positions forward of the outer shield 306 to protect the obverse side 122 of the blades 104 from airflow 118 but still to allow the airflow 118 being deflected from the inner shield 304 to be captures by the outer shield 306 and redirected to the high pressure region.

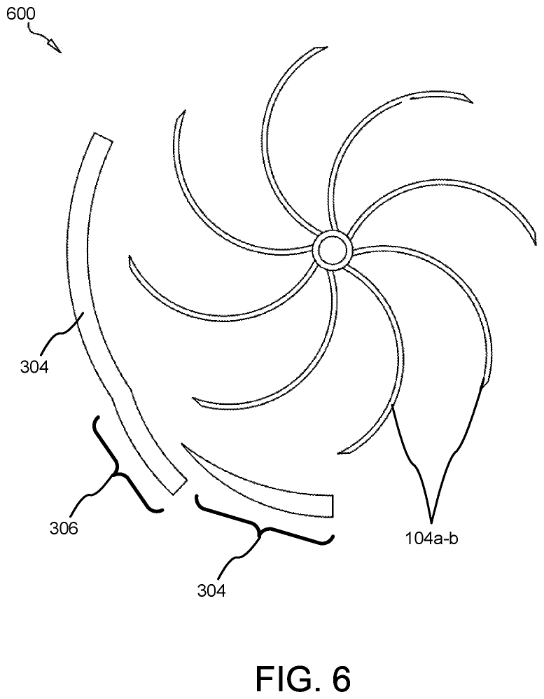

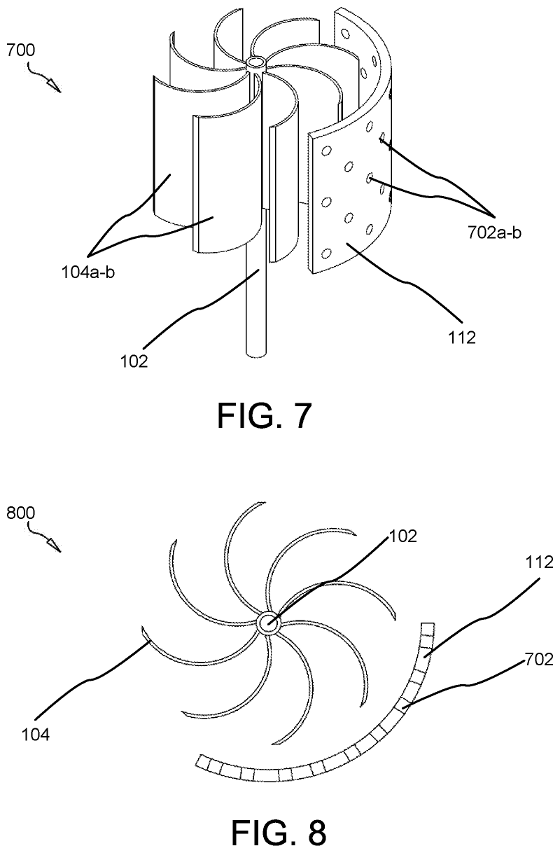

FIGS. 7-8 illustrate perspective views of a VAWT 700, 800 in accordance with the present invention.

A plurality of apertures 702 may position around the perimeter of the shield 112. These apertures 702 may help to redirect airflow 118 into a recess 310 between the shield 112 and the blades 114. Additionally or alternatively, these apertures 702 may catch the airflow 118 passing around the outside and around the shield 112, creating friction between the shield 112 and the oncoming airflow 118 and acting as a wheather vane 202 in positioning the shield in proper axial rotative position around the axis 102. The apertures 702 may be evenly-spaced around the shield, or spaced at irregular intervals. The apertures 702 may be spaced toward only one side of the shield 112 in those embodiments in which the shield 112 rotates in only a clockwise or counterclockwise position. For instance, the apertures 702 may be spaced only across the back half of the shield 112 in those embodiments in which the shield 112 rotates clockwise toward the front of the device 700, 800 (the front of the device being the lower edge shown in FIG. 8).

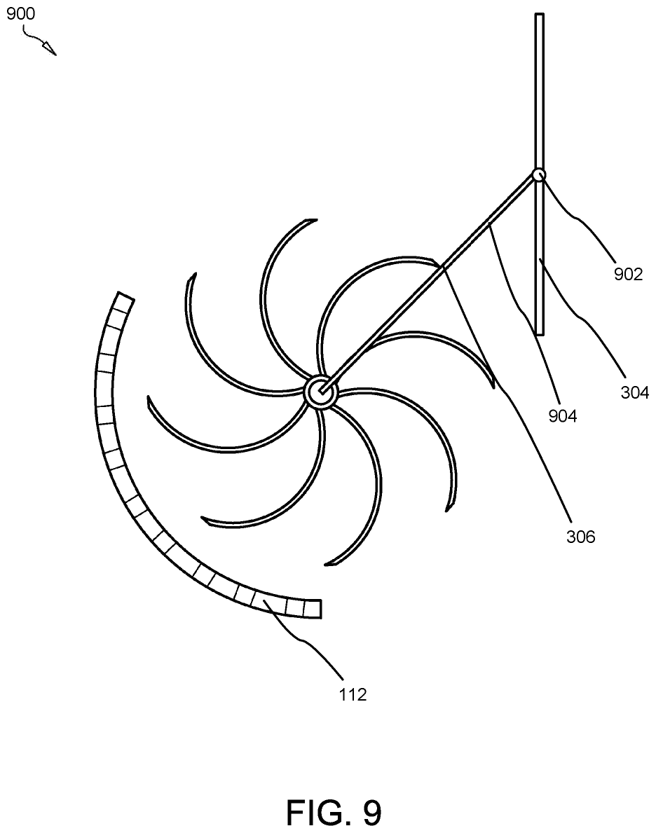

FIG. 9 is a top perspective view of a VAWT 900 in accordance with the present invention.

In some embodiments, the redirection shield 304 is planar on its inner and outer faces as shown. The redirection shield 304 may be affixed to the shaft 126 using a beam 306, wherein the beam 306 affixed to the shaft 102 rather than the shield 112 as shown above.

The beam 306 may be hingedly affixed using a hinge 902 to the redirection shield 304 such that the redirection shield may be angled into the wind in accordance with an operator preference.

In various embodiments, the laterally protruding beam 306 may extend outwardly, cantilevering from the axis 102—often in a direction approximately 110-180 from the center of the shield 112. This beam 306 may itself comprise a plurality of planar surfaces acting to further redirect airflow 118 around the blades 104 in a direction efficacious to increasing pressure on the blades 104 during power generation. For instance, the beam 306 may comprise a planar forward surface 904 which may direct airflow 118 downwardly toward the inferiorly-positioned blades 104.

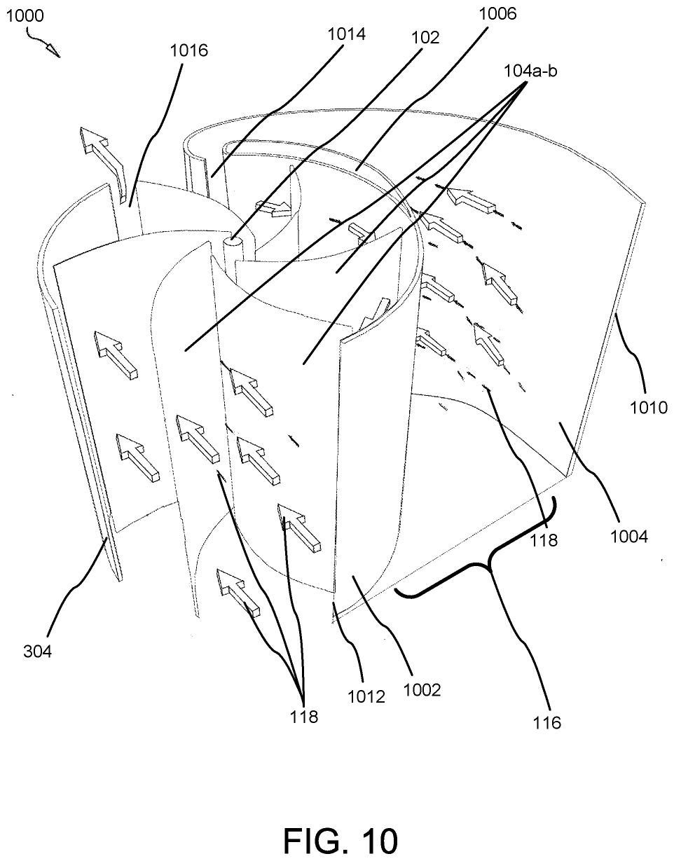

FIG. 10 is an upper, forward perspective view of a VAWT assembly 100 in accordance with the present invention.

The assembly 100 comprises a plurality of blades or rotors 104 mounted on a vertical shaft or vertical axis 102 about which the blades 104 rotate. In various embodiments, the channel 116 is defined by a shield 1002 and scoop 1004. The shield 1002 may comprise the shield 112. In various embodiments, the shield 1002 comprises a piece of planar sheet metal folded over itself as shown to arc outwardly around the blades 104 and form a recess 1006 which angles the airflow 118 back toward the reverse side 114 of the blades 104.

The scoop 1004 may also comprise a piece of sheet metal molded or bent to form the channel 116 and funnel the airflow 118 around behind the blades 104. In various embodiments, the forward edge 1010 of the scoop 1004 is separated by a greater distance from the forward edge 1012 of the shield 1002 in the front of the assembly 1000 than in the back of the assembly 1000 such that the channel 116 defined by the shield 1002 and scoop 1010 diverges, narrows, or funnels the airflow 118 toward the back of the blades 104. The airflow 118 may become pressurized and increase in speed as it travels through the channel 116. The channel 116 may terminate with an opening 114 behind the blades 104 which opening 114 may be separate from the opening 1016 formed between the scoop 1010 and the redirection shield 304.

The shield 1002 and the scoop 1004 may be connected together or independently and free-rotating about the axis 102.

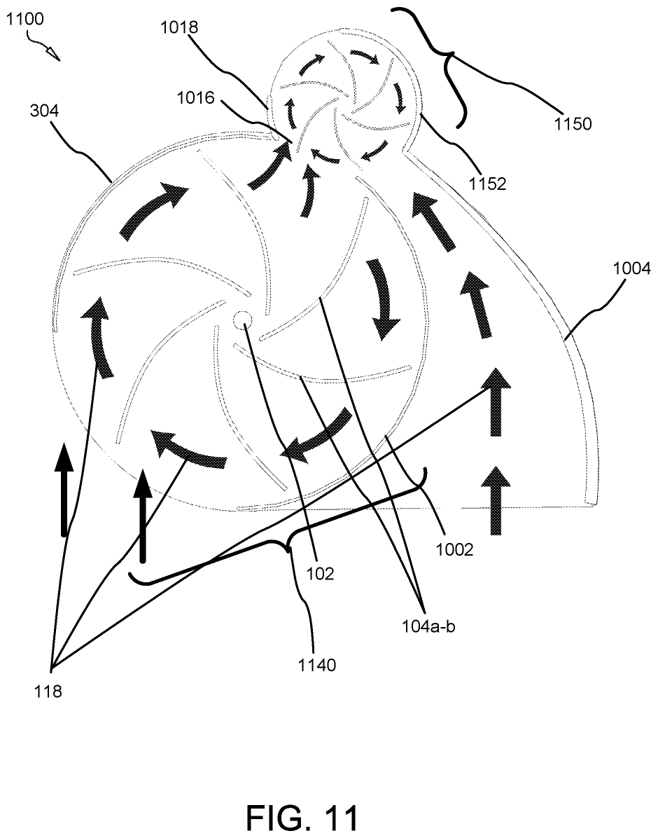

FIG. 11 is a top perspective view of a VAWT assembly 1100 in accordance with the present invention.

The assembly 1100 comprises a secondary VAWT 1150 as shown. The scoop 1004 may be adapted to laterally shield and scoop airflow 118 for both the primary VAWT and the secondary VAWT 1150. In this embodiment, the secondary VAWT may rotate in a direction counter to the primary VAWT 1140 or in the same direction. In the shown embodiment, the secondary VAWT and the primary VAWT 1140 both rotate clockwise from a top perspective.

Airflow 118 exiting the primary VAWT 1140 may be directed into the secondary VAWT 1150 as shown. In some embodiments, the secondary VAWT 1150 comprises a secondary shield 1018 which serves the same basic purpose as the shield 304. The secondary shield 1018 and the shield 304 may be formed as a single integrated piece. The shield 304 and the scoop 1004 may form a substantially quatrefoil shape from a top perspective. In various embodiments, the secondary VAWT 1150 is affixed to one of the shield 304, the scoop 1004, and the shield 1004 such that the secondary VAWT 1150 rotates axially about the axis 102.

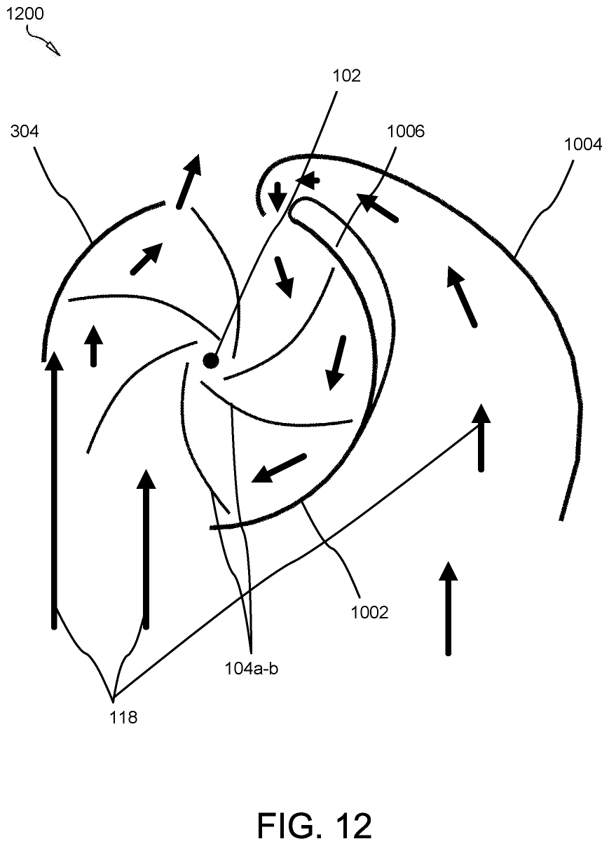

FIG. 12 is a top perspective view of a VAWT assembly in accordance with the present invention.

As shown, the scoop 1004 and the shield 1002 each comprises separate components of the assembly 1200. The shield 1002 and the scoop 1004 may be arcuate. In various embodiments, the shield 1002 and/or the scoop 1004 are higher than the blades 104.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A vertical-axis wind turbine comprising:
a plurality of blades rotating axially about a substantially vertical shaft;
an arcuate wind shield adapted to shield convexly-facing blades on a windward surface of the turbine against contact with oncoming airflow, the wind shield comprising:
an arcuate inner surface spaced away from the blades;
an arcuate scoop arching outwardly from the arcuate inner surface, the arcuate scoop angling forward of a forward edge of the arcuate inner surface, the arcuate inner surface and the arcuate scoop forming a wind channel terminating at one or more ejection ports positioned behind a concave face of the blades, the ejection ports adapted to redirect airflow forced into the open scoop to the concave face of the blades;
wherein the wind shield affixes to the vertical shaft such that the wind shield may rotate axially about the shaft only in one of a clockwise or counterclockwise direction about the vertical shaft.

2. The wind turbine of claim 1, further comprising an arcuate redirection shield positioned laterally to the blades, the redirection shield adapted to redirect airflow around the blades.

3. The wind turbine of claim 2, where the redirection shield is affixed to the shield using one or more arcuate beams.

4. The wind turbine of claim 2, where the redirection shield is hingedly affixed to the shaft using one or more beams.

5. The wind turbine of claim 4, where the redirection shield is hingedly affixed to the shaft using one or more beams.

6. The wind turbine of claim 2, wherein one or more of the redirection shield and the shield define a plurality of apertures spaced across an outer surface.

7. The wind turbine of claim 1, further comprising a wind vane affixed to the shaft and the shield such that the wind vane rotates axially about the shaft.

8. The wind turbine of claim 1, wherein a vertical height of the scoop exceeds a vertical height of the blades.

9. A vertical-axis wind turbine comprising:
a plurality of blades rotating axially about a substantially vertical shaft;
an arcuate wind shield adapted to shield convexly-facing blades on a windward surface of the turbine against contact with oncoming airflow, the wind shield comprising an arcuate inner surface spaced away from the blades;
an arcuate scoop arching outwardly laterally from the arcuate inner surface, the arcuate scoop and arcuate inner surface forming a wind channel terminating at an opening positioned behind a concave face of a blade, the scoop adapted to redirect airflow forced into the scoop to a concave face of a blade;
wherein the arcuate scoop and the inner surface are taller than the blades.

10. The wind turbine of claim 9, wherein one or more of the inner surface and arcuate scoop are formed from sheet metal.
